(19) United States
(12) Patent Application Publication
(10) Pub. No.: US 2005/0191226 A1
(43) Pub. Date: Sep. 1, 2005

(54) Hydroxylapatite powder, porous body and method for preparing thereof

(75) Inventors: Wei-Hsing Tuan, Taipei (TW); Ya-Jen Yu, Taipei (TW); Chin-Yi Chen, Taipei (TW)

Correspondence Address: DENNISON, SCHULTZ, DOUGHERTY & MACDONALD, 1727 KING STREET, SUITE 105, ALEXANDRIA, VA, 22314, US

(73) Assignee: NATIONAL TAIWAN UNIVERSITY

(21) Appl. No.: 10/910,571

(22) Filed: Aug. 4, 2004

(30) Foreign Application Priority Data
Aug. 5, 2003 (TW) 092121433

(51) Int. Cl. C01F 11/04

(52) U.S. Cl. 423/307; 419/10

(57) ABSTRACT

This invention relates a method for preparing hydroxylapatite powder. The hydroxylapatite powder was obtained by heating fish scales to remove the organic component and collect the inorganic powder. In addition, this invention provides a hydroxylapatite porous body, which was obtained by sintering said hydroxylapatite powder.

### FIELD OF THE INVENTION

This invention relates to a method for preparing hydroxylapatite powder. The hydroxylapatite powder was obtained by heating fish scales to remove the organic ingredient and collect the inorganic powder. In addition, this invention provides a hydroxylapatite porous body, which was obtained by sintering, said hydroxylapatite powder.

Hydroxylapatite (Ca₁₂(PO₄)₆(OH)₂) is one of biocompatibility biomedical materials, and is already applied on the dental faculty and orthopedics material. Hydroxylapatite is similar in the component or the structure with the bone inorganic nature, belongs to one kind of the bio-ceramics to be possible to implant the human body, has the good mechanical property, and outstanding bio-compatibility, once hydroxylapatite in the liquid very easily react with the biological tissue to form the chemical bond, therefore, it extremely suits applies to the biomedicine as a patching material, and already is applied in the dental faculty and on orthopedics bio-medical material.

The tricalcium phosphate (Ca₃(PO₄)₂) is an absorbable biomedical ceramics, in contacts the body tissue, the tricalcium phosphate can slowly be dissolved in the body fluid. If the bio-medical ceramic of the hydroxylapatite has some tricalcium phosphate ingredient, after implanted in the human body, the tricalcium phosphate can gradually be dissolved to the body fluid, the empty space will be substituted by its peripheral body tissue. This bio-activity bio-medical ceramics causes the biomedical ceramic and body tissue in close integration finally.

Therefore, using a heat treatment to process a hydroxylapatite material let the partial hydroxylapatite phase be transformed into the tricalcium phosphate and causes the biomedicine ceramic material to become the concurrently hydroxylapatite and the tricalcium phosphate merit. It might be a big promotion of this kind of biomedicine material in the skeleton and usability of the tooth patching material.

In recent years, many researchers try to prepared a biomedicine ceramic material, which the hydroxylapatite and the tricalcium phosphate existed concurrently. The attempt using the hydroxylapatite itself the better mechanical property and the easy to form the skeleton to tie the structure, as well as the higher activity of the tricalcium phosphate in the body fluid, to promote the serviceability of the calcium phosphate bio-medicine ceramics.

Hydroxylapatite is the principal constituent of bone. As early as in 1976, hydroxylapatites were prepared by synthesis by Aoki (Japanese) and Jarcho (American) respectively. However, after the hydroxylapatite was implanted into the organism, the formability of ossein is influenced by the process temperature and the grain size of this synthesis hydroxylapatite. In order to induces the skeleton formation, it must maintain the certain proportion between the phosphate dissolve in body fluid and the bone formation, and needs the accuracy control the purity, granularity, crystal and porosity of the hydroxylapatite.

### BRIEF DESCRIPTION OF THE ART

The technology in regard to fish scale usage, U.S. Pat. No. 5,905,093 disclosed a calcium rich preparation which is prepared by soaking fish scales in an acidic solution for a defined period of time. China Patent CN1080929A disclosed a method for producing cosmetic material by hydrolysis the fish scale into a polypeptide, and further condensation reacting to form acylated peptide. China Patent CN1098597A disclosed a method for producing nutrition by using a high pressure steam treat fish scale to prepare calcium, phosphorus rich collagen gel of fish scale.

Above mentioned technologies in regard to fish scale treatment are relative low temperature processes (lower than 100° C.). These processes are related to extract the organic ingredient of fish scale. Due to the rich amount of organic ingredient, the extracted material is not suitable for biomedical material.

Regarding to the hydroxylapatite applied as an implant material on dental faculty or orthopedics, U.S. Pat. No. 5,279,831 disclosed multilayered hydroxylapatite coating for patching material. The first layer of hydroxylapatite coating having a condenser crystal and following layer having looser structure of hydroxylapatite crystal may induce bone tissue into the interspace to improve the adhesion. U.S. Pat. No. 5,817,326 disclosed titanium alloy coated with hydroxylapatite by treating the coating with different heating condition to form a condenser layer and a looser layer of hydroxylapatite.

Republic of China patent TW-408023 disclosed a composite bio-medical material, which obtained by co-sintering the bone and alumina and coating a layer of calcium pyrophosphate on the surface of alumina base material. The sponge bone of the natural bone material soaked in a slurry contained calcium metaphosphate, and then sintered.

Although the bio-medical compound material may result in the better mechanical strength and the surface of the hydroxylapatite/tricalcium phosphate (HAP/TCP), the exist of a various properties between the surface material and base material will make it not easy to compatible. Therefore, the prior biomedical titanium alloy should be treated with a complicated surface processing to improve the adhesion of HAP/TCP coating.

Republic of China patent TW-420604 disclosed method for producing a porous ceramic, which used a thermal treatment a sponge bone of cow to remove the organic ingredient and then soaked in different concentration phosphate solutions, dried and sintered at 900° C., a HAP/O-TCP porous ceramic was obtained finally. This hydroxylapatite porous body contained a 65% of porosity. This advantage is suitable for bone tissue or blood into the void. However, its poor mechanical strength can not resist impact and the application was limited.

In addition, hydroxylapatite may mix with other materials to produce a biological activity and compatible patching materials. Republic of China patent TW-420604 disclosed an absorbable composite granule, which forms a fibrous network structure by mix collagen and hydroxylapatite or calcium phosphate.

### SUMMARY OF THE INVENTION

It is an object of this invention to provide a method for preparing the hydroxylapatite powder, using fish scale as starting material and thermal treating the fish scale to remove the organic ingredient. This is a method using the waste fish scale to produce a biomedical material. Due to the nature of fish scale, the obtainable hydroxylapatite powder is safe and starting material is economic.

It is another object of this invention to provide a biocompatible hydroxylapatite powder, which is obtained by using fish scale as starting material and thermal treating the fish scale to remove the organic ingredient. This biocompatible hydroxylapatite powder can be applied as a biomedical material on dental faculty or orthopedics.

It is another object of this invention to provide a hydroxylapatite powder having nanometer level micro-crystal, which is obtained by using fish scale as starting material and thermal treating the fish scale under a temperature condition to control the grain size of hydroxylapatite powder. This nanometer level micro-crystal hydroxylapatite powder is a bio-active and biocompatible filler material.

It is another object of this invention to provide a hydroxylapatite powder having nanometer level micro-crystal. This hydroxylapatite powder is suitable to be used for sintering a hydroxylapatite porous body.

It is another object of this invention to provide a hydroxylapatite porous body, which was obtained from sintering of above-mentioned hydroxylapatite by a powder metallurgy process. Due to the crystallization of hydroxylapatite, this hydroxylapatite porous body having better mechanical strength. Additional, some nanometer level micro-crack on the granule of hydroxylapatite made the hydroxylapatite porous body have potential to become the new bio-medical material for dental faculty or orthopedics.

### BRIEF DESCRIPTION OF THE DRAWINGS

FIG. 1: X-ray diffraction pattern for Ghana fish scale thermal treatment at 700° C. for one hour.

FIG. 2: Thermal weight loss of Mugil cephalus fish scale.

FIG. 3A: X-ray diffraction pattern for Mugil cephalus fish scale at different temperatures thermal treatment over 900° C. for 1 hour.

FIG. 3B: X-ray diffraction pattern for Mugil cephalus fish scale at different temperatures thermal treatment below 900° C. for 1 hour.

FIG. 4A: The aspect of the hydroxylapatite powder obtained from Mugil cephalus fish scale was heating at 600° C.

FIG. 4B: The aspect of the hydroxylapatite powder obtained from Mugil cephalus fish scale was heating at 900° C.

FIG. 4C: The aspect of the hydroxylapatite powder obtained from Mugil cephalus fish scale was heating at 1100° C.

FIG. 5: microstructure of a hydroxylapatite porous body.

### DETAILED DESCRIPTION OF THE INVENTION

This invention relates a method for preparing hydroxylapatite powder. The hydroxylapatite powder was obtained by thermal treatment fish scales to remove the organic component and collect the inorganic powder, wherein the thermal treatment temperature was over 600° C. According to a Differential Scanning Calorimeter (DSC) analysis result, there is no organic residual after the fish scale was heated over 600° C. According to an X-ray diffraction (XRD) analysis result, there is small amount of tricalcium phosphate was observed when the fish scale was heating over 1300° C. As the fish scale was heating up to 1300° C., some of the hydroxylapatite transformed to the tricalcium phosphate.

The hydroxylapatite powder of this invention is an inorganic powder obtained by thermal treatment fish scale to remove the organic ingredient. The fish scale treated with a high temperature will result a high purity hydroxylapatite. The partial of hydroxylapatite will be transformed to a tricalcium phosphate at very high temperature. According to an X-ray diffraction (XRD) analysis result, there is at least 95% of hydroxylapatite in the residual as the fish scale was heating at a temperature below 1300° C. There is at least 5% of tricalcium phosphate was observed as the fish scale was heating at a temperature over 130. Meanwhile, the grain size of the hydroxylapatite powder will be increasing as raising the thermal treatment temperature. The grain size of hydroxylapatite crystal, which obtained from the fish scale was thermal treated under 600° C. for one hour, was smaller than 0.06 nanometer and there is some micro-crack appeared on the hydroxylapatite powder. It was smaller than 0.15 nanometer for the 700 thermal treatment and greater than several micrometers after 1300° C. thermal treatment.

Furthermore, this invention was trying to use a powder metallurgy method to sinter the high purity hydroxylapatite powder to a hydroxylapatite porous body. A hydroxylapatite porous body having smaller than 0.5 micrometer of micro-crack was obtained.

The hydroxylapatite have excellent biocompatibility. However, as prior method, the hydroxylapatite powder prepared by a chemical synthesis which existing some problem that grain size of the hydroxylapatite always is too coarser and hard to control the purity of hydroxylapatite. Therefore, this invention developed a method for preparing the hydroxylapatite by using fish scale as raw material. This hydroxylapatite contained some trace ingredient existing in the fish scale, such as iron or zinc, which may increase the biocompatibility.

The scale is a fish skin derivative and has protection function for preventing microorganism, disease and infect. In general, fish scale can be divided into Bony Ridge Scale [symbol] Ganiod and Placoid, wherein the bony ridge scale further divided into Cycloid Scale and Ctenoid Scale. The bony ridge scale is most common scale of the fish.

This invention used the scale taken from various kinds of fish, including Ghana fish, Chanos chanos, Mugil cephalus. Thermal treating the fish scales at 700° C. and analysis the composition of the fish scale residual inorganic by X-ray diffraction. The experimental results shown all the residual inorganic contained hydroxylapatite and there is no limitation to this invention method the source of fish. It seems that any kind of fish scale can be taken from fish is possible use for this invention.

The hydroxylapatite powder preparation in the experiments of this invention was using scale of Mugil cephalus, which is a very common fish in Taiwan. The scale of Mugil cephalus is classified as a Bony Ridge Scale, and sub-classified as a Ctenoid Scale.

### EXPERIMENT 1

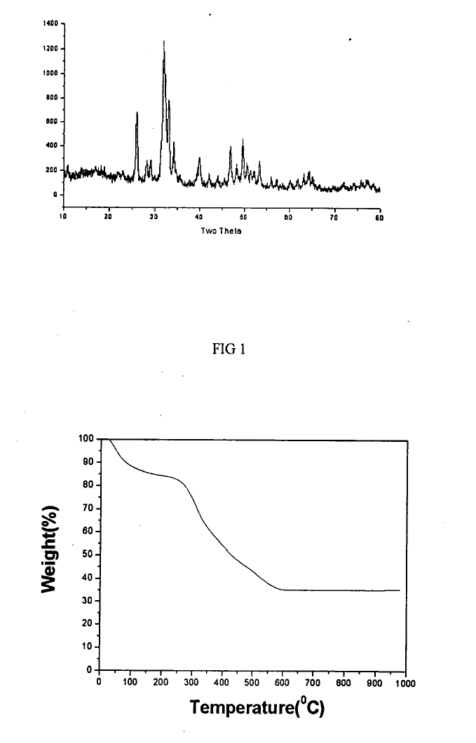

Thermal treatment the scale of Ghana fish by a heating program of heating rate of 5° C. per minute to 700° C., and hold for one hour, then cooling rate of 5° C. per minute to room temperature. The resulted residual was grind into powder, and examined its crystal phase by using XRD. FIG. 1 is the XRD result of the hydroxylapatite powder, which obtained from Ghana fish scale thermal treatment at 700° C. The crystal phase shown on the XRD result is hydroxylapatite.

### EXPERIMENT 2

The Mugil cephalus fish scale was soak in a 0.5N—NaOH solution to remove grease, then rinsing by distilled water and drying. The change of weight of scale during thermal treatment in air was examined by a Differential Scanning Calorimeter (DSC). Refer to FIG. 2, shown the thermal treatment fish scale results a 60% of thermal weight loss after the temperature up to 600° C.

After many repeat test, the fish scale heated up to 600° C. will cause 55% to 65% of thermal weight loss, this conclusion indicated thermal treatment fish scale may recover about 40% by weight, based on fish scale, of inorganic material.

### EXPERIMENT 3

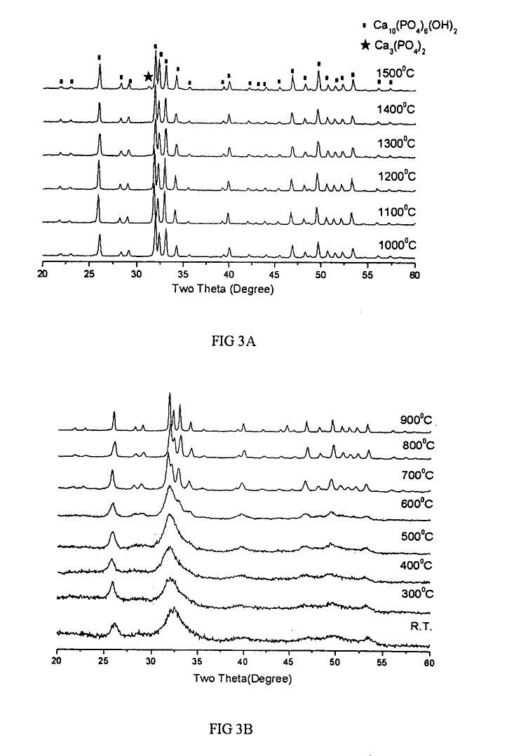

The starting material and process of this experiment are same as Experiment 2. The washed and cleaned fish scale was divided into 12 specimens, thermal treatment in air by the heating rate of 5° C. per minute, and heating up to a temperature between 300° C. and 1500° C., respectively Then, the temperature decreased by the cooling rate of 5° C. per minute. The thermal treatment at different temperature results 12 samples of scale residuals. These samples were examined by XRD to analysis their crystal phase. The XRD result shown on FIG. 3 and explained that there is amorphous hydroxylapatite or some very fine hydroxylapatite crystal exists in the original fish scale. After thermal treatment, the characteristic peak of hydroxylapatite crystal appeared obviously, and indicated the crystal of hydroxylapatite was strong. According to the XRD results, there are only hydroxylapatite crystal phase existed in the residual of scale after thermal treatment between 300° C. and 1200° C. There is some of tricalcium phosphate was detected in the residual of scale after thermal treatment over 1300° C. In this experiment, the XRD was operating under 30 KV-20 mA, the XRD having a 5% of resolution for tricalcium phosphate, therefore, indicating the amount of the tricalcium phosphate was about 5% of the scale residual after 1300° C. thermal treatment. The amount of the tricalcium phosphate will be increasing as the thermal treatment temperature raising. About 10% of tricalcium phosphate detected after 1500° C. thermal treatment for one hour.

### EXPERIMENT 4

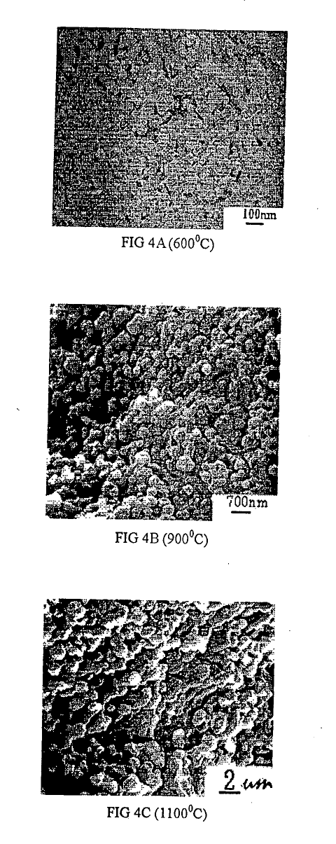

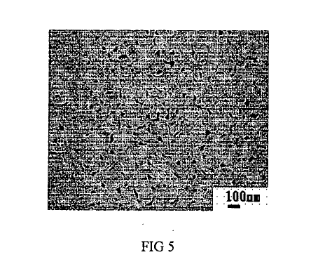

This experiment is using the hydroxylapatite powder sample obtained in experiment 3 and using a SEM (Scanning Electronic Microscope) to observe the outward appearance of the fish scale after high temperature treatment. According to the XRD analysis result of the experiment 3, the hydroxylapatite crystal appeared obviously as the fish scale was thermal treated under a temperature over 600° C. Therefore, this experiment set the thermal treatment temperatures were 600° C. to 1300° C. Using a SEM to observe the hydroxylapatite crystals and to analysis the grain size. Refer to FIG. 4A to FIG. 4C, the grain size of hydroxylapatite crystal, which obtained from the fish scale was thermal treated under 600° C. for one hour, were between 50 and 60 nanometer. It was between 100 and 150 nanometer for the 700° C. thermal treatment and between 400 and 500 nanometer for the 900° C. thermal treatment. After 1100° C. thermal treatment, the grain size greater than about one micrometer (refer to the Table 1).

TABLE 1
the different grain size versus different hydroxylapatite
powder, which obtained by thermal treating the fish
scale under various temperatures.

| | Temperature | | | | |
|---|---|---|---|---|---|
| | 600° C. | 700° C. | 900° C. | 1100° C. | 1300° C. |
| Grain Size | 50-60 nm | 100-150 | 400-500 nm | 1-2 μm | 3-20 μm |
| | | nm | | | |

In addition, the observed result of the SEM shown that the grain size of the hydroxylapatite powder will be increasing as raising the thermal treatment temperature, and proven that the grain size of the hydroxylapatite powder can be controlled by changing the thermal treatment temperature.

Regarding to the raw material applied for sintering a hydroxylapatite porous body, the hydroxylapatite powder must have finer grain. This invention provides a nanometer level hydroxylapatite powder. For other application needs coarser grain hydroxylapatite powder, this invention can provide a micrometer level hydroxylapatite powder.

### EXPERIMENT 5

This experiment is using the hydroxylapatite powder obtained in experiment 3. Preparing hydroxylapatite slurry by adding suitable amount of water to the hydroxylapatite powder, which obtained from thermal treat the fish scale at 600° C. for one hour. The hydroxylapatite slurry was pouring on a plaster board to dry off the hydroxylapatite slurry. After drying, the hydroxylapatite was sintered at 700° C. for 30 min. The surface of the sintered hydroxylapatite porous body was inspected by SEM, refer to FIG. 5, the porosity is about 10 nm.

There is rare sintering research regarding the use nanometer level hydroxylapatite powder. Our research is trying to use a powder metallurgy forming and sintering process to produce a hydroxylapatite porous body by using the hydroxylapatite powder. There are many powder metallurgy forming methods, such as slurry casting, die casting, even a ceramic injection molding, can be applied in this invention. According to our experimental results, the nanometer level hydroxylapatite powder can produce various scale of hydroxylapatite porous body by a sintering method of powder metallurgy process. Though some sintering result obtained a hydroxylapatite porous body which pore size is smaller than 0.5 micrometer, to obtain the hydroxylapatite porous body with different pore size or different mechanical strength need more research. However, the starting material of hydroxylapatite porous body is the hydroxylapatite powder prepared from fish scale, which is a bio-waste. This safe and cheap raw material will be extremely potential to become the new bio-medical material. The hydroxylapatite porous body after processing can be applied as an implant material on dental faculty or orthopedics.

Above experiments disclosed using suitable thermal treatment a hydroxylapatite powder can be preparing from fish scale. Furthermore, the hydroxylapatite can be processing to produce a hydroxylapatite porous body for biomedical application.

1. A method for preparing hydroxylapatite powder, comprising using thermal treatment to fish scale to remove the organic ingredient to obtain an inorganic powder.

2. The method of claim 1, wherein the thermal treatment is heating fish scale at temperature at least 600° C.

3. The method of claim 1, wherein the thermal treatment is heating fish scale at temperature up to 1300° C.

4. The method of claim 1, wherein the thermal treatment is heating fish scale under the air atmosphere.

5. The method of claim 1, wherein the fish scale is taken from fishes having bony ridge scale.

6. The method of claim 1, wherein the fish scale is taken from fishes having cycloid scale or ctenoid scale.

7. The method of claim 1, wherein the fish scale is taken from Mugil cephalus.

8. A hydroxylapatite powder, which is an inorganic powder obtained by thermal treatment to fish scales.

9. The hydroxylapatite powder of claim 8 having at least 95% of hydroxylapatite ingredient.

10. The hydroxylapatite powder of claim 8 having at least 5% of tricalcium phosphate ingredient.

11. The hydroxylapatite powder of claim 8, wherein the grain size of hydroxylapatite powder is smaller than 20 micrometer.

12. The hydroxylapatite powder of claim 8, wherein the grain size of hydroxylapatite powder is smaller than 0.15 micrometer.

13. The hydroxylapatite powder of claim 8, wherein the grain size of hydroxylapatite powder is smaller than 0.06 micrometer.

14. The hydroxylapatite powder of claim 8, wherein the fish scale is taken from fishes having bony ridge scale.

15. The hydroxylapatite powder of claim 8, wherein the fish scale is taken from fishes having cycloid scale or ctenoid scale.

16. The hydroxylapatite powder of claim 8, wherein the fish scale is taken from Mugil cephalus.

17. Ahydroxylapatite porous body, which is produced by powder metallurgy forming process by using the hydroxylapatite powder of claim 8 and sintering at temperatures between 600° C. and 1500° C.

18. The hydroxylapatite porous body of claim 17, wherein the pore size of the porous body is smaller than 0.5 micrometer.
